(19) United States
(12) Patent Application Publication
(10) Pub. No.: US 2007/0253282 A1
(43) Pub. Date: Nov. 1, 2007

(54) Mixer apparatus

(75) Inventor: John A. Dalton, New York, NY (US)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Dalton Enterprises, Inc.

(21) Appl. No.: 11/731,005

(22) Filed: Mar. 28, 2007

Related U.S. Application Data
(60) Provisional application No. 60/787,035, filed on Mar. 29, 2006.

(51) Int. Cl. B01F 7/00

(52) U.S. Cl. 366/201; 366/200

(57) ABSTRACT

Apparatus and an associated method is disclosed for mixing material in a container in response to an applied rotational force at one end of a shaft protruding through an aperture in a skirted lid placed over the open end of the container imparting a rotating motion to an agitator-mixing head at the opposite end of the shaft. The skirted lid provides a snug-fit or seal between the container and the skirted lid.

### CROSS REFERENCE TO RELATED APPLICATION

Reference is made to and priority claimed from U.S. provisional application Ser. No. 60/787,035, filed Mar. 29, 2006, entitled MIXER APPARATUS.

### TECHNICAL FIELD

The present invention relates generally to mixer apparatus and deals more particularly to a mixer apparatus for use with a container bucket for stirring or mixing the contents carried in the container.

### BACKGROUND OF THE INVENTION

Various materials, liquids and/or compositions are sold in lid-sealed containers or buckets that require removal of the lid for access and stirring of the contents to prepare the materials, liquids and/or compositions for usage. The containers are typically made of plastic, metal or other suitable material to carryout the intended function.

In order for the contents of the container to be stirred or mixed, the lid or top used for sealing the open-end of the container is removed or separated from the container. A stick, paddle or some other implement is used to stir or mix the contents in the open top container often with the consequence that the contents tend to spill or splash out of the container during the stirring or mixing process onto the user or the area surrounding the container.

In some instances, particularly where the material, liquid and/or composition has a thick or slurry like characteristic, it is difficult and often tiresome to manually stir or mix the material, liquid and/or composition into a homogeneous mixture with a further consequence that the contents are not properly prepared for usage which often results in the product not achieving its intended function and goal in usage or application for example to a surface.

What is needed is a mixer apparatus that can be used in place of the container sealed-lid for mixing the contents in the container bucket without splashing or spilling the contents during the mixing process.

### SUMMARY OF THE INVENTION

In a broad aspect of the invention, mixer apparatus is presented for mixing material in a container in response to an applied rotational force at one end of a shaft protruding through an aperture in a skirted lid placed over the open end of the container for imparting a rotating motion to an agitator-mixing head at the opposite end of the shaft. The skirted-lid provides a snug-fit or seal between the container and the skirted-lid.

### BRIEF DESCRIPTION OF THE DRAWINGS

FIG. 1 shows an example of the lid of the mixing apparatus embodying the present invention placed on the open-end of a container bucket.

FIG. 2 illustrates the lid of the mixing apparatus embodying the present invention shown lifted from the open-end of a container bucket to reveal the agitator-mixing head positioned within the container bucket.

FIG. 3 shows an example of the mixing apparatus embodying the present invention as seen from the bottom of the agitator-mixing head looking toward the inwardly facing surface of the lid.

FIG. 4 is a fragmentary view of a portion of the skirt attached to the lid and shown in a flexed outward position.

FIGS. 5A-5C show an example of the agitator-mixing head of the mixing apparatus embodying the invention.

FIG. 6 shows the end portion of the shaft protruding through the aperture in the lid of the mixing apparatus embodying the present invention in a tilted or slanted orientation with respect to the surface of the lid for locating the agitator-mixing head at a desired position within the container.

FIG. 7 shows the shaft holding the agitator-mixing head releasably held by deformable clips on the outward surface of the lid of the mixing apparatus defining a self-storing state of the mixing apparatus embodying the present invention.

### WRITTEN DESCRIPTION OF THE INVENTION

The mixer apparatus of the present invention may be utilized to stir the ingredients or composition make up of various products, for example but not limited to bituminous and acrylic emulsion surface treatments including driveway sealers, conditioners, and resurfaces such as those manufactured by the assignee of the present invention under a number of tradenames and trademarks including Latex-ite®, Airport Grade®, Optimum®, Formula 5® and other all of which are available from Dalton Enterprises, Inc. and commercially at sales outlets for example, The Home Depot®.

The mixer apparatus embodying the present invention is also suitable for use with material, liquid and/or compositions other than those described above such as, for example but not limited to paint, drywall compound, roofing sealers and the like and therefore the mixer apparatus of the present invention is disclosed herein by way of example and not limitation.

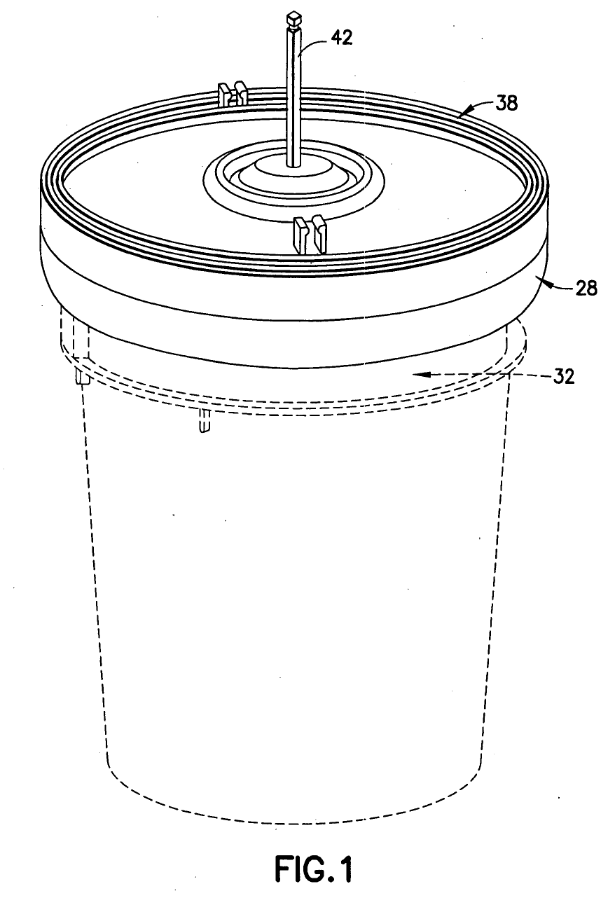

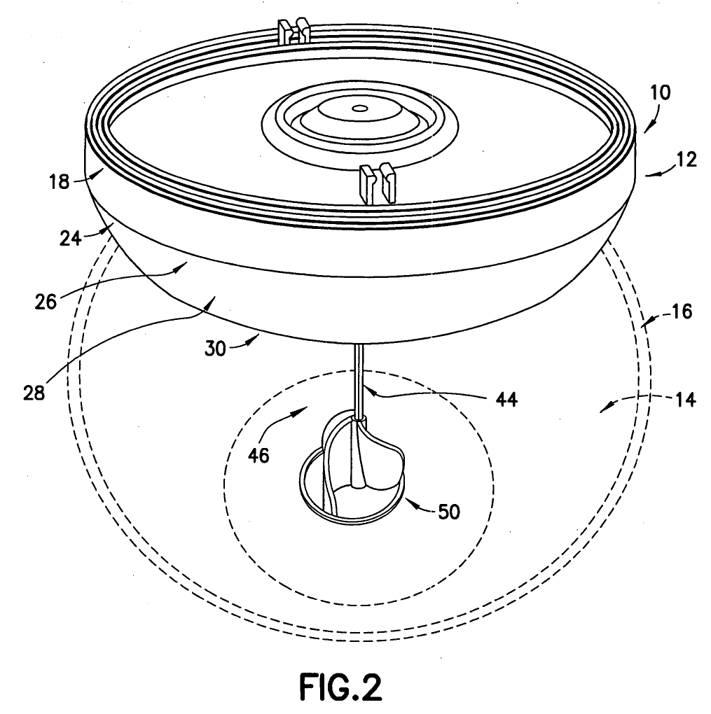

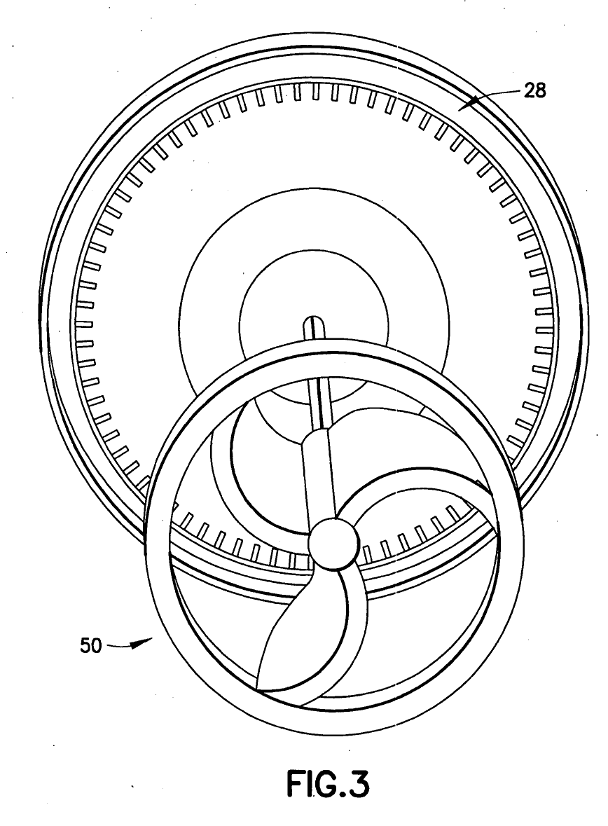

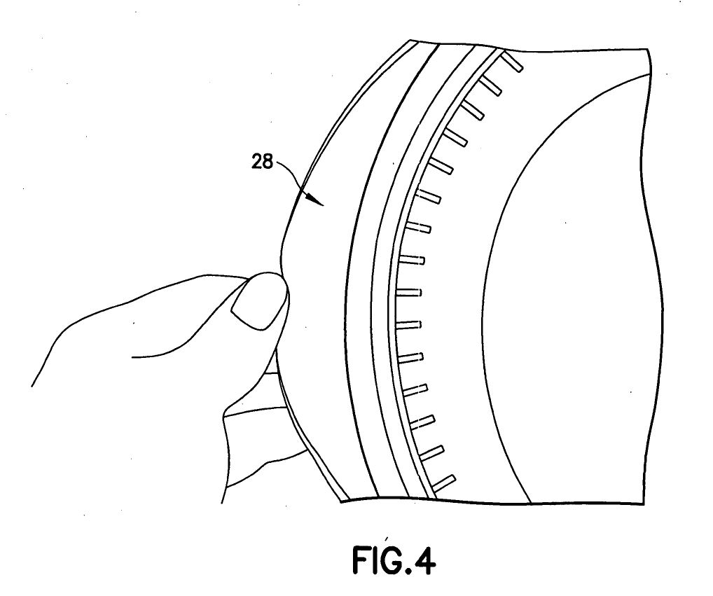

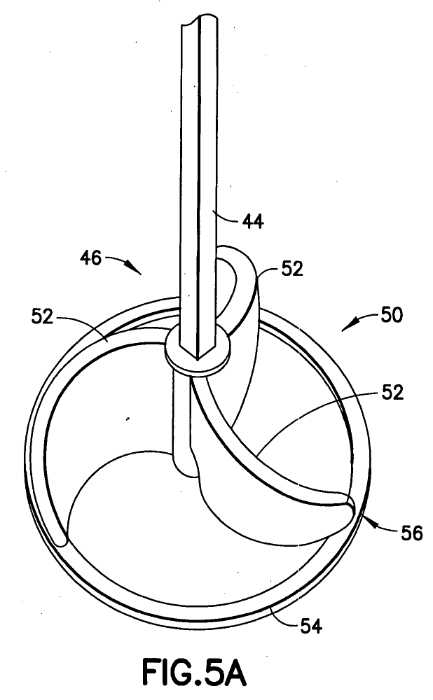

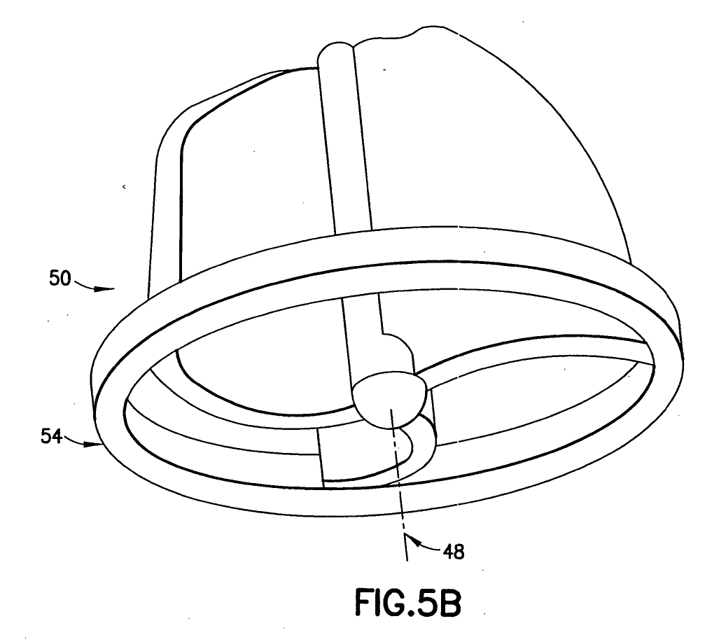

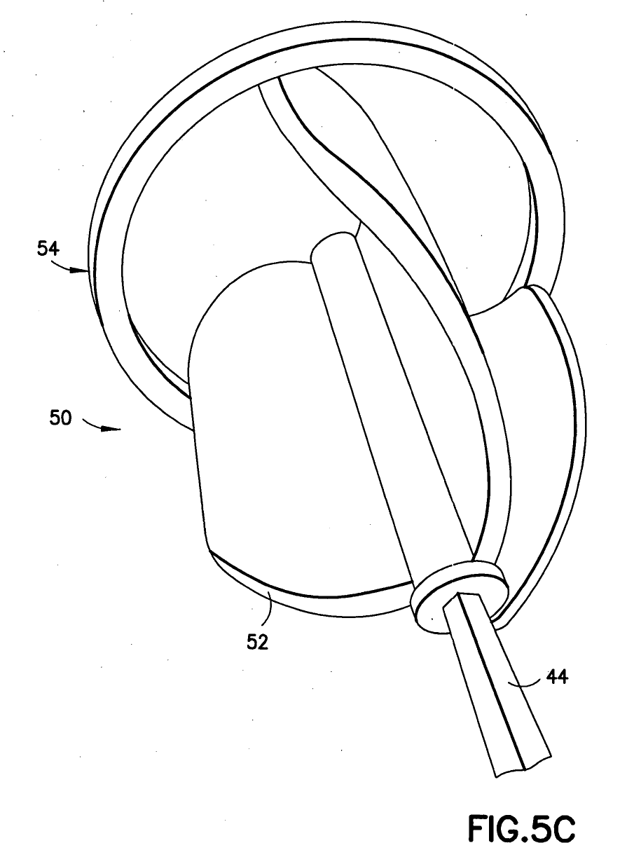

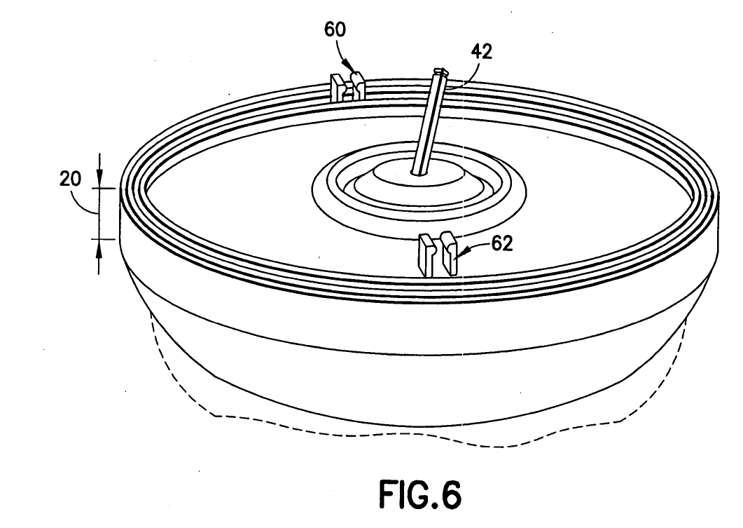

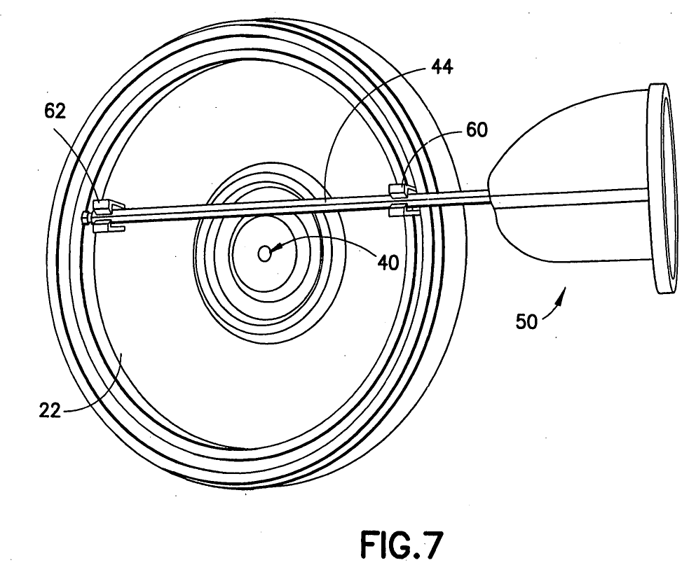

Turning now to FIGS. 1-7 and considering the invention in further detail, the mixer apparatus is generally designated 10 in the drawings and includes a skirted-lid 12 that is used in place of the container sealed-lid to cover the open-end 14 of a container generally designated 16. The container 16 is not limited to shape and size and the skirted lid 12 is sized and shaped to accommodate the container size and shape. It is however contemplated that the container is of a shape and size that may be easily handled by a consumer such as a pail or bucket although there is no practical restriction to the container shape.

In the illustrated example of the invention, the skirted lid 12 has a suitable diameter to accommodate and fit over the opening of the container bucket. The skirted-lid 12 has a lid portion 38 and is made of a suitable material such as for example polypropylene, or other suitable material to carry out the intended function. The lid portion may be shaped and formed by any suitable means such as injection molding, blow molding, vacuum forming or any other suitable forming means.

The skirted-lid 12 has a peripheral wall 18 extending a suitable distance 20 downward from the outwardly facing surface 22 of the skirted-lid 12. The lower-most edge portion 24 of the peripheral wall 18 is arranged and configured to receive the upper edge portion 26 of a flexible skirt 28. The flexible skirt 28 is made of a suitable resilient, memory retentive material for example an elastomeric material or a thermoplastic material. At least a portion such as the lower-most portion 30 of the flexible skirt 28 is arranged for a snug fit against the outer peripheral surface wall 32 of the container 16 to achieve a snug-like seal between the skirted-lid 12 and the outer wall surface 32 of the container when the skirted-lid 12 is placed over the open end 14 of the container.

A mixing rod generally designated 46 includes an agitator-mixing head generally designated 50 at one end of the shaft 44. The agitator-mixing head 50 is arranged with a number of vanes 52, 52 circumferentially positioned about the longitudinal axis 48 of a shaft 44 forming an axially elongated rotary fan-like configuration. The vanes 52, 52 are configured and shaped to “scoop” the contents in the container upwardly during the mixing or stirring process to facilitate and assist in the mixing of the contents to achieve a homogeneous mixture. A peripheral strengthening ring 54 is located along the bottom outer edge or tip region 56 of the vanes 52 for additional structural support and rigidity. The agitator-mixing head 50 may be axially pressed onto the shaft or may be molded onto the shaft or otherwise attached in any suitable manner to achieve the intended result.

The lid portion 38 of the skirted-lid 12 is configured with an aperture 40 in its outwardly facing surface wall 22 for receiving and passing therethrough one end 42 the shaft 44 opposite the agitator-mixing head 50. The aperture 40 is centrally located and is sized to accommodate the diameter of the shaft 44 so the shaft may be tilted and angled in the container through the aperture but made sufficiently snug to prevent the contents in the container from splashing out during the stirring process. The aperture 40 may be oblong shaped to accommodate the tilting of the shaft.

The shaft 44 has a suitable length such that the end 42 of the shaft 44 opposite the agitator-mixing head 50 extends above the outwardly facing surface wall 22 a suitable distance to be received for example in the chuck of a drill which is used to impart an applied force to the shaft end 42 for imparting a rotating movement to the agitator-mixing head 50 to stir or mix the contents in the container. The shaft 44 is made of a suitable material such as for example steel for transferring the applied force at the end 42 to the agitator-mixing head 50. The applied force to the end 42 of the shaft 44 may be from any source or device such as for example a drill. The drill may be any standard well known type to carry out the intended function and may be battery or electrical cord powered.

The outwardly facing surface wall 22 of the skirted-lid 12 is arranged with two spaced apart clip-like deformable bosses 60, 62 to receive and releasably hold the shaft 44 for convenient self-storage and packaging purposes.

The mixer apparatus 10 is used in a method for mixing contents in an open-ended container in response to an applied rotational force at one end 42 of a shaft 44 protruding through an aperture 40 in a skirted-lid 12 placed over the open end 14 of the container 16 to impart a rotation motion to an agitator-mixing head 50 at an end of the shaft 44 opposite the protruding end 42. The shaft 44 is tilted at an angle with respect to the plane of an outwardly facing surface wall 22 of the skirted-lid 12 for positioning the agitator-mixing head 50 at any of a number of possible different desired positions within the container 16 to insure thorough mixing of the contents in the container 16. The method also includes forming a snug fit seal between the skirted-lid 12 and the outer peripheral wall surface 32 of the container 16 to restrict contents within the container 16 from splashing out during the mixing or stirring process.

A mixer apparatus embodying the present invention has been presented above in several examples and by way of illustration rather than limitation and includes all embodiments whether the features are taken singularly or in combination as contemplated in accordance with the invention and are considered to be within the specification.

The invention claimed:

1. Apparatus, comprising:
a lid configured for placement over an open end of a container bucket to cover said open end;
a mixing rod configured as an axially elongated shaft having a predetermined desired length arranged with an agitator-mixing head at a first end and a second end opposite said first end configured for receiving an applied rotational force to impart a rotating movement to said agitator-mixing head at said first end; and
said lid further configured with an aperture generally centrally located on an upper outwardly facing surface of said lid and sized for receiving said second end of said shaft so that a portion of said shaft in the region of said second end protrudes above said upper outwardly facing surface of said lid and said agitator-mixing head is positioned within said container in response to said lid being placed over said open end of said container.

2. The apparatus as defined in claim 1 wherein said lid is further configured with a skirt along an outer peripheral region of said lid such that said skirt is arranged to overlap a portion of the outer peripheral surface in the region of said container open end in response to said lid being placed over said open end of said container.

3. The apparatus as defined in claim 1 wherein said skirt is formed as an integral portion of said lid.

4. The apparatus as defined in claim 1 wherein said skirt is constructed of a suitable sheet-like material extending downwardly from said lid a predetermined desired distance to a lower edge spaced from said upper surface of said lid.

5. The apparatus as defined in claim 4 wherein said skirt suitable sheet-like material has a memory retentive somewhat stretchable and conformable material such that the inwardly facing lower edge region surface of said skit forms a contact surface seal with said outwardly facing peripheral surface of said container.

6. The apparatus as defined in claim 5 wherein said skirt is made of a suitable elastomeric material.

7. The apparatus as defined in claim 1 wherein said lid is constructed as a plastic injection molded lid.

8. The apparatus as defined in claim 1 wherein said aperture is oblong shaped for accommodating tilting of said shaft extending there-through for positioning said agitator-mixing head at a desired location within said container.

9. The apparatus as defined in claim 1 wherein said agitator-mixing head further comprises a plurality of axially spaced radial extending somewhat curved contoured vanes configured for imparting an upward moving force on a material held within said container in response to rotation of said agitator-mixing head in a first direction for mixing the material.

10. The apparatus as defined in claim 9 wherein said plurality of vanes are equidistant axially spaced from one another.

11. The apparatus as defined in claim 9 wherein said agitator-mixing head is further configured with a circumferential ring for adding rigidity to said vanes.

12. The apparatus as defined in claim 9 wherein said agitator-mixing head is made of a suitable injection molded plastic material.

13. The apparatus as defined in claim 1 wherein said lid is further configured with spaced apart clips located on said upper surface of said lid for receiving and releasably holding said shaft such that said shaft and attached agitator-mixing head is self-storing on said lid.

14. Apparatus, comprising:
means for mixing material in a container in response to an applied rotational force at one end of a shaft protruding through an aperture in a skirted lid placed over an open end of said container for imparting a rotating motion to an agitator-mixing head at an end of said shaft opposite said protruding end, said skirted lid proving a snug fit sealing means between said container and said lid.

15. Method, comprising:
mixing material in an open end container in response to an applied rotational force at one end of a shaft protruding through an aperture in a skirted lid placed over said open end of said container to impart a rotation motion to an agitator-mixing head at an end of said shaft opposite said protruding end, and
tilting said shaft at an angle with respect to the plane of an outwardly facing surface of said skirted lid for positioning said agitator-mixing head at any of a number of possible different desired positions within said container to insure through mixing of the material in said container

16. The method as defined in claim 15 further comprising forming a snug fit seal between the skirted lid and the outer peripheral surface of the container to restrict material within the container form splashing out during the mixing process.
